(19) United States
(12) Patent Application Publication
(10) Pub. No.: US 2024/0300088 A1
(43) Pub. Date: Sep. 12, 2024

(54) ROBOT FOR LOCOMOTION IN INTERIOR SPACES OF PIPES, AND OPERATING METHOD

(71) Applicant: Voith Patent GmbH, Heidenheim (DE)

(72) Inventors: Lorenz Lenhart, Ulm (DE); Marcel Ripper, Essingen (DE)

(73) Assignee: Voith Patent GmbH, Heidenheim (DE)

(21) Appl. No.: 18/669,709

(22) Filed: May 21, 2024

Related U.S. Application Data
(63) Continuation of application No. PCT/EP2022/077279, filed on Sep. 30, 2022.

(30) Foreign Application Priority Data
Dec. 2, 2021 (DE) 10 2021 131 720.7

(51) Int. Cl. B25J 9/06; B25J 9/12; B25J 9/16

(52) U.S. Cl. CPC B25J 9/065; B25J 9/12; B25J 9/1633

(57) ABSTRACT

A robot for locomotion in a pipe includes: star carriers including a supporting structure and clamping elements with a fixed part, a moving part, and a motor, the moving part being retracted and extended, the fixed part being connected with the supporting structure, the supporting structure including a frame with an outer contour, the fixed part being attached to the outer contour such that the star carriers can be clamped onto the interior space of the pipe when the moving part is extended; feed elements, the feed elements including a linear drive with a motor for changing a length, the feed elements extending between two fixed parts of adjacent star carriers; and a control unit for controlling the clamping elements and the feed elements.

### CROSS REFERENCE TO RELATED APPLICATIONS

This is a continuation of PCT application no. PCT/EP2022/077279, entitled “ROBOT FOR LOCOMOTION IN INTERIOR SPACES OF PIPES, AND OPERATNG METHOD”, filed Sep. 30, 2022, which is incorporated herein by reference. PCT application no. PCT/EP2022/077279 claims priority to German patent application no. 10 2021 131 720.7, filed Dec. 2, 2021, which is incorporated herein by reference.

### BACKGROUND OF THE INVENTION

### 1. Field of the Invention

The present invention relates to mobile robots, and, more particularly, to mobile robots for use in interior spaces of pipes.

### 2. Description of the Related Art

Mobile robots for use in pipe interiors are known from the state of the art. For example, CN 105257950 A discloses such a robot. The robot includes a front and a rear housing assembly, which can be moved relative to one another with the assistance of an intermediate drive group located between them. For this purpose, the drive group includes a spindle drive and three linear guides. The housing assemblies are each supported against the inner wall of the pipe by three so-called self-locking assemblies. The radial extension of the self-locking assemblies can be adjusted using an adjusting nut so that the robot can be adapted to different pipe diameters. However, the scope for this adaptation is rather limited due to the design. The design of the self-securing assemblies means that the disclosed robot can only move in one direction in the pipe. In addition, the robot cannot be used in pipes that have a significant curvature.

What is needed in the art is a mobile robot for use in pipe interiors which do not have the aforementioned disadvantages. What is also needed in the art is a simple modular design, which can be easily disassembled and reassembled, and can also be inserted into pipe interiors through small openings.

### SUMMARY OF THE INVENTION

The present invention relates to a mobile robot for use in interior spaces of pipes, for example in pipelines and optionally in waterways of hydropower plants, for example a pressure pipeline. The robot can serve as a platform for various tools for cleaning, sandblasting, coating and inspecting internal surfaces of pipes. The present invention also relates to operating methods of the mobile robot for locomotion and adaptation of the robot to various pipe interiors.

The following items form part of the present disclosure:

Item 1. A robot for locomotion in an interior space of a pipe, including at last two star carriers, wherein each star carrier includes a supporting structure and at least three clamping elements, and wherein each clamping element comprises a fixed part a moving part and a motor, and wherein moving part by way of the motor can be retracted and extended along an axis with respect to associated fixed part, and wherein the fixed part is connected with the supporting structure, and wherein each supporting structure is designed as a frame with an outer contour, characterized in that, the fixed parts of the clamping elements are attached to the outer contour of associated supporting structure in such a way that respective star carrier can be clamped onto the interior of the pipe when the moving parts of associated clamping elements are extended, and wherein the robot includes at least three feed elements, wherein each feed element is designed as a linear drive with a motor for changing the length, and wherein each feed element extends between fixed parts of two clamping elements which belong to adjacent star carriers, and wherein the robot includes a control unit which is designed in such a manner that it can control all of the clamping elements and all feed elements.

Item 2. The robot according to item 1, wherein an elastic element is arranged on a foot of the moving part of the clamping elements.

Item 3. The robot according to items 1 or 2, wherein at least one roller and one hold-down element are arranged on one foot of the moving part of the clamping elements, wherein a roller is attached to the foot by way of a lever and a hinge in such a way that the roller can be swung out in axial direction of the clamping element beyond one end of associated foot, and wherein the roller is pressed against an inner wall of the pipe by way of the hold-down element when the respective foot touches the inner wall of the pipe.

Item 4. The robot according to item 3, wherein the hold-down element is designed as an active actuator.

Item 5. The robot according to item 3 or 4, wherein two rollers are attached to one foot of the moving part of clamping elements.

Item 6. The robot according to item 5, wherein the hold-down element is designed as a spring element.

Item 7. The robot according to one of items 3 to 6, wherein the connection of the feed elements with associated clamping elements is designed in such a way that they allow feed elements to be tilted in relation to associated clamping elements, and wherein the control unit is designed in such a way that it can control feed elements independently of each other.

Item 8. The robot according to one of the preceding items, wherein a force sensor is

arranged on one foot of the moving part of clamping elements, which can detect the force with which foot is pressed against an inner wall of the pipe.

Item 9. The robot according to one of the preceding items, wherein a distance sensor is located on one foot of the moving part of the clamping elements, which can detect the distance between the foot and an inner wall of the pipe.

Item 10. A method of locomotion of a robot according to one of the items, in an interior space of a straight pipe includes at least the following steps:
S1: Releasing a star carrier by retracting associated clamping elements;
S2: Moving the star carrier which was released in S1 in the direction of locomotion by changing the length of feed elements connected with star carrier;
S3: Bracing of the star carrier which was released in S1 by extending associated clamping elements.

Item 11. A method of locomotion of a robot according to one of the items 7 to 9 in an interior space of a curved pipe includes at least the following steps:
S1: Releasing a star carrier by retracting the associated clamping elements;
S2-1: Moving the star carrier which was released in S1 in the direction of locomotion by changing the length of the feed elements connected with the star carrier;
S2-2: Tilting of the star carrier which was released in S1 in the direction of locomotion by changing the length of feed elements connected to the star carrier for the event that the star carrier released in S1 is located in a curved pipe section, until all clamping elements of this star carrier are arranged perpendicular to the inner pipe wall;
S3: Bracing of the star carrier that was released in S1 by extending the associated clamping elements.

Item 12. A method for adaptation of a robot according to one of the items 1 to 9 to a pipe having a large diameter, wherein existing supporting structures are replaced by larger supporting structures, and wherein all other elements of the robot remain unchanged.

Item 13. A method for adaptation of a robot according to one of the items 1 to 9 to a greater load, wherein the number of clamping elements per star carrier is increased.

Item 14. A method for adaptation of a robot according to one of the items 1 to 9 to a pipe having a non-cylindrical cross section, wherein existing supporting structures are replaced by other supporting structures, and wherein the other supporting structures are designed such that associated clamping elements can be attached to same in such a way, that feet of clamping elements can be pressed vertically against the inside wall of the pipe.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings:

FIG. 1 is a mobile robot according to the invention;

FIGS. 2.1A, 2.1B, 2.1C show a detail of a clamping element;

FIGS. 2.2A, 2.2B show a detail of a clamping element;

FIGS. 3.1A, 3.1B, 3.1C, 3.1D, 3.1E show a sequence of motion in a straight pipe;

FIGS. 3.2G, 3.2H, 3.21, 3.2J, 3.2K show a sequence of motion in a straight pipe;

FIGS. 4A, 4B, 4C, 4D show a sequence of motion in a curved pipe;

FIGS. 5A, 5B, 5C show adaptations to various pipes or requirements; and

FIG. 6 is an adaptation to various pipe shapes.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

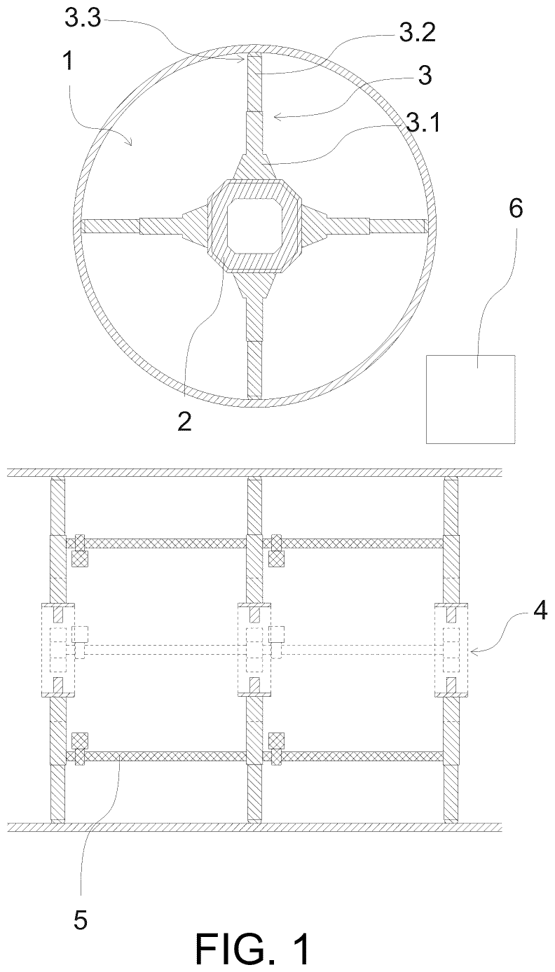

FIG. 1 is a schematic illustration of a mobile robot in a pipe, according to the present invention. The upper part of FIG. 1 shows the robot in a section perpendicular to the pipe axis and the lower part of FIG. 1 shows the robot in a section along the pipe axis. The robot is labeled 1. Robot 1 includes at least two star carriers which are arranged in axial direction, one after the other. Therefore, only one star carrier is visible in the upper part of FIG. 1. In the lower part of the figure a star carrier is labeled 4. A star carrier 4 includes a supporting structure and at least three clamping elements. Illustrated star carrier 4 includes four clamping elements, each of which is labeled with 3. The illustrated supporting structure is identified with 2 and has the shape of a square frame with chamfered corners. However, many other shapes are conceivable. Generally, supporting structure 2 is designed as a frame having an outer contour. The frame may have an opening on the inside, as shown in FIG. 1, or it may be closed. Each clamping element 3 includes a fixed part and at least one moving part. In FIG. 1, the fixed part of a clamping element is designated 3.1 and the moving part of a clamping element is designated 3.2. Fixed parts 3.1 of clamping elements 3 are connected with supporting structure 2. Moving part 3.2 of each clamping element 3 can be retracted and extended along an axis with respect to corresponding fixed part 3.1. The outward-facing end of moving part 3.2 of a clamping element 3 is referred to as foot and is identified with 3.3 in FIG. 1. Clamping elements 3 are attached to the outer contour of supporting structure 2 in such a way that star carriers 4 can clamp onto the interior of the pipe when moving parts 3.2 of clamping elements 3 are extended. Each clamping element 3 is supported internally on supporting structure 2 and externally with foot 3.3 on the inner wall of the pipe. Each clamping element 3 includes a separate motor for retracting and extending moving parts 3.2, which is mounted in or on fixed part 3.1. It is advantageous if the axes of clamping elements 3 belonging to a star carrier 4 are arranged in one plane, as this results in a very simple structure. However, for robots that are only intended to move in straight pipes, and for star carriers 4 with more than three clamping elements 3, arrangements are also conceivable in which the axes of clamping elements 3 are arranged in different planes. In the example shown in FIG. 1, the axes of two clamping elements which are located opposite one another could be arranged in a separate plane; in other words, the two planes formed in this way could intersect the pipe axis at different points.

Two adjacent star carriers 4 of a robot 1 according to the present invention are connected to each other by so-called feed elements. In FIG. 1, a feed element is labeled 5. Each feed element 5 extends between a fixed part 3.1 of a clamping element 3 of first star carrier 4 and a fixed part 3.1 of a clamping element 3 of second star carrier 4.

If the robot according to the present invention has three clamping elements 3 per star carrier, then the robot includes three feed elements 5 per space between the star carriers, whereby these are connected to all clamping elements of the star carriers located adjacent to the space; in other words, a feed element 5 extends in each case between a clamping element 3 of first adjacent star carrier 4 and a clamping element 3 of second adjacent star carrier 4. If the star carriers have more than three clamping elements, it is not absolutely necessary that 3 feed elements are arranged between all the clamping elements. However, a greater number of feed elements is advantageous if either high loads are present and/or large gradients have to be overcome. The maximum possible number of N_{VE} of feed elements 5 of robot 1 is given by formula N_{VE}=N_{KE}*(N_{TS}−1), wherein N_{KE} is the number of clamping elements 3 per star carrier 4, and where N_{TS} is the number of star carriers 4 of robot 1. As already previously mentioned, a robot in minimal configuration (two star carriers 3 with three clamping elements 3 each) therefore, includes exactly three feed elements 5.

Each feed element 5 is a linear drive and includes a motor for changing the length of respective feed element 5. In this context, the term “motor” is to be understood broadly in connection with the clamping elements and the feed elements. These motors can be, for example, electric motors or hydraulic or pneumatic drives.

In addition, it is advantageous if the connection of feed elements 5 with associated clamping elements 3 is designed in such a way that they allow feed elements 5 to be tilted relative to corresponding clamping elements 3. This can be achieved, for example, by way of a connection by way of a ball joint or an equivalent hinge arrangement. Such a connection enables the robot to move in curved pipes (see below).

It is advantageous if all clamping elements 3 of robot 1 are identical, and if all feed elements 5 of the robot are identical. As a result, the robot can be very easily adapted to different pipes and load requirements.

FIG. 1 also shows a control unit, which is identified with 6 and is part of robot 1. Control unit 6 is designed in such a way that all feed elements 5 can be controlled with control unit 6. Feed elements 5 can thereby be controlled either simultaneously or-for more flexibility and to allow movement in curved pipe sections-independently of each other. In addition, control unit 6 is designed in such a way that all clamping elements 3 can be controlled with it. Clamping elements 3 of a star carrier can be controlled either simultaneously or, for more flexibility, independently of each other. The connection of control unit 6 with the controlled elements can occur via cables or wirelessly.

It is advantageous if 3 elastic elements are attached to feet 3.3 of the clamping elements. On the one hand, this improves the frictional connection between the inside wall of the pipe and the foot and, on the other hand, ensures that feet 3.3 of clamping elements 3 can adapt to unevenness of the inside wall of the pipe.

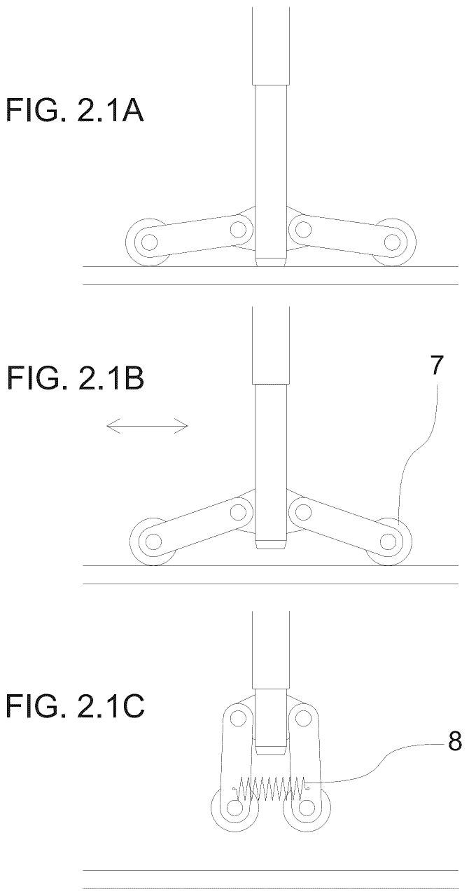

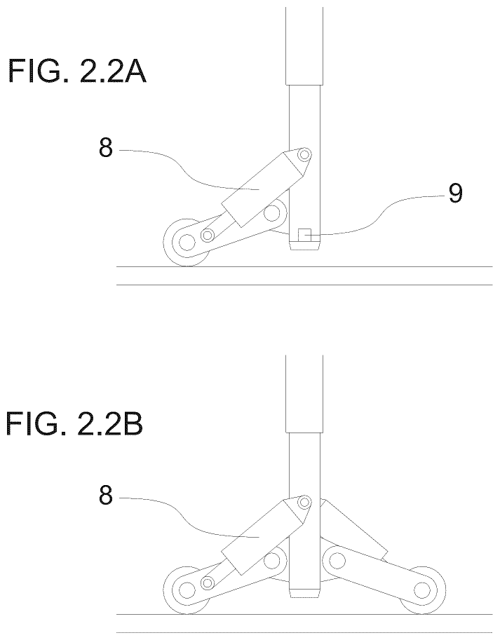

FIGS. 2.1A, 2.1B, 2.1C show an advantageous detail of a clamping element 3 in three different positions (A), (B) and (C). These are rollers that are attached to the foot of the clamping element shown. A roller is identified with 7. The connection of rollers 7 with the clamping element occurs by way of levers and hinges, which are designed in such a way that the rollers can be swung out in the axial direction of the clamping element beyond the base end of the clamping element. Rollers 7 enable improved guidance of the robot's star carriers inside the pipe if the clamping elements are retracted to such an extent that the feet of the robot move away from the inside pipe wall.

FIG. 2.1A shows the situation when the clamping element is pressed against the inside wall of the pipe; in other words when the corresponding carrier star is clamped in the pipe. FIG. 2.1B shows the situation when the clamping element in question is retracted to such an extent that there is a gap between the foot and the inner wall of the pipe. Rollers 7 rest on the inside wall of the pipe in the arrangement shown. In the illustrated arrangement, the corresponding star carrier can be moved forward or backward inside the tube, as indicated by the double arrow. It is clear that the rollers must be attached to the clamping element in such a way that they can perform their task during such a movement. FIG. 2.1C shows a situation when the clamping element is retracted to such an extent that even rollers 7 can no longer make contact with the inside wall of the pipe. This can occur, for example, when obstacles on the inside wall of the pipe have to be overcome.

For the rollers to be able to fulfil their function in every conceivable orientation of the associated clamping element, a so-called hold-down element is required, which can press the rollers against the inside wall of the pipe in the situation illustrated in FIG. 2.1A and also in the situation of FIG. 2.1B. FIG. 2.1C shows a possible embodiment of a hold-down element which is identified with 8. Hold-down element 8 consists of a spring element that engages with the levers of the two rollers.

If the feed elements are designed to be tilted, hold-down element 8 must be strong enough to keep the foot away from the inside wall of the pipe against the weight force of the star carrier in question. At this point, it should be noted that you can also distribute the weight force over several feet. For example, the robot shown in FIG. 1 can be rotated by 45° around the pipe axis, so that the weight force is now evenly distributed between the two feet at the bottom.

It should be mentioned that in a transition from the situation shown in FIG. 2.1B to the situation shown in FIG. 2A, the drive of the respective clamping element must overcome the hold-down force acting on the rollers if the hold-down element concerned is a passive element, such as a spring. If the hold-down elements can be actively controlled (see next section), then the hold-down force can be reduced or switched off when the clamping elements are extended. The same also applies to the situation shown in FIG. 2.1C, since no hold-down force is required here either.

FIG. 2.2A and FIG. 2.2 show two further embodiments of rollers and hold-down elements. In the embodiment according to FIG. 2.2A, only one roller per clamping element is provided. An active actuator 8 acts as a hold-down element, which can be driven pneumatically, hydraulically, or electrically. Such active actuators 8 are controlled by way of the control unit.

Moreover, the foot of the clamping element can include sensors that can be used, among other things, to regulate the distance between the foot and the inside wall of the pipe. FIG. 2.2A indicates such a sensor which is identified with 9. This can be a distance sensor which, for example, is capacitively or optically effective. The foot can also include other types of sensors. For example, a force sensor can detect the force with which the foot is pressed against the inside wall of the pipe when the associated star carrier is clamped into the pipe. Another sensor with which the foot can be advantageously equipped is an optical sensor for detecting the angle at which the axis of the respective clamping element is oriented relative to the inside wall of the pipe. This information can be used particularly advantageously when the robot is to move in curved pipe sections. The use of sensors on the feet of the clamping elements is not limited to the embodiments shown in FIG. 2.2A, FIG. 2.2B, but the aforementioned sensors can be used advantageously in any conceivable embodiment of the robot.

In the embodiment according to FIG. 2.2B, two rollers are used per clamping element and one active actuator per castor as hold-down element 8.

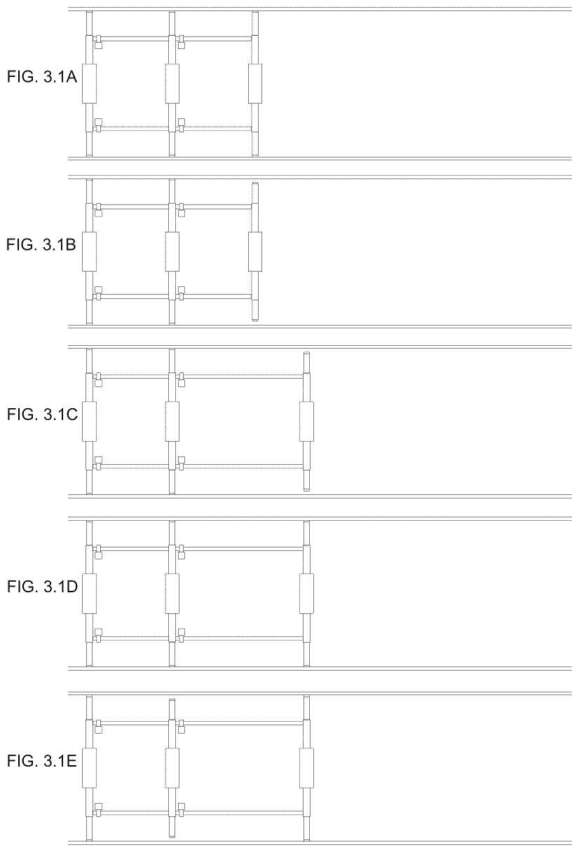

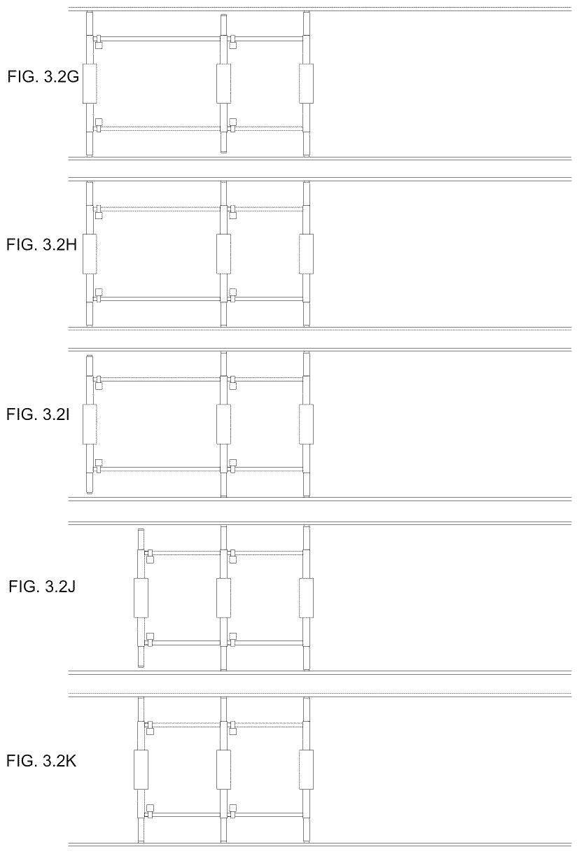

FIGS. 3.1A-3.1E and 3.2G-3.2K are a simplified representation of the motion sequence of a robot according to the present invention in a straight pipe section. In principle, this sequence of motion can be carried out by a robot with feed elements, which are firmly connected—in other words are not tiltable—to the associated clamping elements, and which does not include rollers. If, however, the weight of the star carriers and their additional load is reasonably high, then the forces occurring in FIGS. 3.1B, 3.1C, 3.21, 3.2J are so great due to the leverage effect that it is advantageous to provide rollers which can absorb at least part of these forces. However, if the feed elements of the robot are attached in a tiltable manner to the clamping elements, then correspondingly strongly held-down rollers must also be provided, because without them the released star carriers could not be held in the position shown in the examples of FIGS. 3.1B, 3.1C, 3.21, 3.2J. For the sake of simplicity, however, the representation of potentially present rollers has been omitted.

FIG. 3.1A shows the starting position. All star carriers are braced against the pipe wall, that is, all clamping elements are extended accordingly. In FIG. 3.1B, the star carrier at the front in the direction of movement was released by retracting the associated clamping elements slightly. This star carrier is now held in position either solely by the non-tilting feed elements connected to it or by rollers that are held down with corresponding strength. In FIG. 3.1C the front feed elements have been extended so that the front star carrier has been moved in the direction of locomotion. In FIG. 3.1D all star carriers are again braced against the pipe wall. In FIG. 3.1E, the central star carrier was released by retracting the associated clamping elements slightly. In FIG. 3.2G, the center star carrier was moved in the direction of locomotion. To do this, all feed elements connected to the moving star carrier were used by retracting those at the front and extending those at the rear. In FIG. 3.2H all star carriers are again braced against the pipe wall. In FIG. 3.21, the star carrier located at the very rear in the direction of locomotion was released by retracting the associated clamping elements slightly. In FIG. 3.2J the feed elements connected to this star carrier were retracted so that the rear star carrier was moved in the direction of locomotion. In FIG. 3.2K all star carriers are again braced against the pipe wall.

A robot in a minimal configuration, that is, with only the two star carriers located at the front and the feed elements located between them, would have already run through a complete motion cycle with steps shown in FIG. 3.1A to FIG. 3.2H (that is, FIGS. 3.1A, 3.1B, 3.1C, 3.1D, 3.1E, 3.2G, 3.2H). It is clear that the sequence of motion shown in FIGS. 3.1A-3.1E and 3.2G-3.2K works in an analogous way for locomotion in the opposite direction without any problems.

The motion sequence shown in FIGS. 3.1A-3.1E and 3.2G-3.2K works not only in a horizontal direction, but also in any other conceivable orientation of the straight pipe. However, the loads on the individual elements then change. Thus, in a vertical movement of the robot, the rollers and their hold-down elements are not encumbered by the weight force. On the other hand, the feed elements must be able to support the entire weight force of the respectively moving star carriers. Similar considerations apply to the clamping force of the respectively clamped star carriers, which must support the entire weight of the robot. The modular design according to the present invention allows the robot to be easily adapted to different additional weights (see below).

In the described sequence of motion in a straight section of pipe, the clamping elements of a star carrier are always simultaneously retracted or extended. The same also applies to the feed elements located between two star carriers. In the sequence of motion in a curved section of pipe described below, the latter circumstances no longer apply.

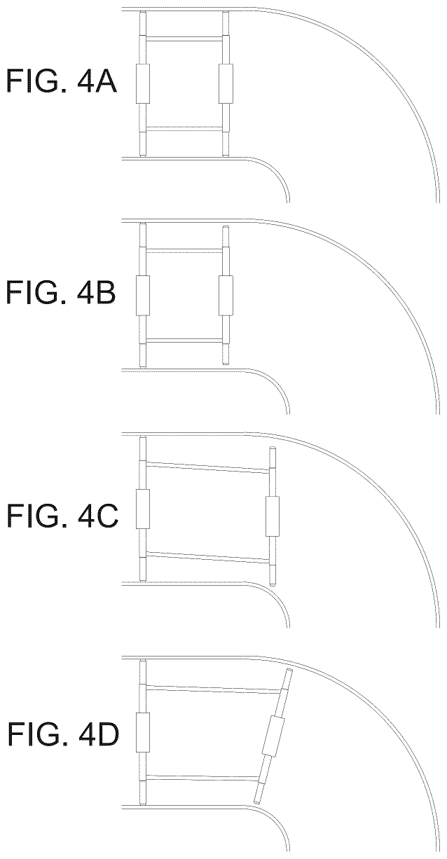

FIGS. 4A, 4B, 4C, 4D show the sequence of motion in a curved pipe. For simplicity's sake, the robot has only two star carriers. FIG. 4A shows the starting position. Both star carriers are braced against the pipe wall, in other words, all clamping elements are extended accordingly. The robot is located in a straight section of pipe just before the pipe exhibits a curved downward progression. In FIG. 4B, the star carrier located at the front in the forward direction of locomotion was released by retracting the associated clamping elements slightly. This star carrier is now held in position by the held down rollers. In FIG. 4C the feed elements were extended so that the front star carrier was moved in the direction of locomotion. In the illustrated arrangement in FIG. 4C, the front star carrier is now in the curved pipe section. In this arrangement, the clear width in the vertical direction is greater at the position of the front star carrier than in the non-curved pipe section. Thus, due to the influence of the weight force, the front star carrier sags slightly downwards, as shown in FIG. 4C. In the shown sectional, the feed elements shown, and the star carriers, form a parallelogram. In FIG. 4D the front star carrier, which is located in the curved pipe section, was tilted in relation to the rear star carrier in such a way that all clamping elements of the front star carrier are arranged perpendicular to the inside pipe wall, so that this star carrier can be safely clamped in the next step (not shown) by extending the clamping elements inside the pipe. Subsequently, as in FIGS. 3.1A-3.1E and 3.2G-3.2K, the rear star carrier would be released and then moved in the direction of locomotion. If the rear star carrier is also located in the curved pipe section, it would also be tilted in such a way that its clamping elements are arranged perpendicular to the inside pipe wall prior to being clamped against the inside pipe wall.

It is advantageous if the feed step width is reduced if the relevant star carrier to be advanced is located in a curved pipe section.

There are several possibilities to detect this situation, in other words, to determine whether a star carrier is in a curved pipe section. The most direct option would be to use the previously referred to sensors to detect the angle at which the clamping elements in question are located relative to the inside wall of the pipe. Detection can also occur with the assistance of distance sensors, which record the distance between the feet of the clamping elements and the inside wall of the pipe. As already mentioned above, the distance between at least a few clamping element feet and the inside wall of the pipe increases when the associated star carrier is moved into a curved pipe section. Both types of sensors can also be used for tilting the star carrier. If distance sensors are used, the length of the feed elements is varied to minimize the sum square of the detected distances. It must be stated that slight deviations from the vertical orientation of the clamping elements are tolerable. This is especially true if elastic elements are attached to the foot ends of the clamping elements, because these can compensate for such deviations. This means that the star carrier in question can be securely clamped in the pipe even if the axes of its clamping elements deviate by a small angle from the vertical direction relative to the inside pipe wall.

On the basis of the above, the following methods present themselves for locomotion of a robot according to the present invention inside a pipe.

One method of locomotion of a robot inside a straight pipe includes at least the following steps:
S1: Releasing a star carrier by retracting the associated clamping elements;
S2: Moving the star carrier released in S1 in the direction of locomotion by changing the length of the feed elements connected to the star carrier;
S3: Bracing of the star carrier that was released in S1 by extending the associated clamping elements.

One method of locomotion of a robot inside a curved pipe includes at least the following steps:
S1: Releasing a star carrier by retracting the associated clamping elements;
S2-1: Moving the star carrier released in S1 in the direction of locomotion by changing the length of the feed elements connected to the star carrier;
S2-2: Tilting the star carrier released in S1 in the direction of locomotion by changing the length of the feed elements connected to the star carrier for the event that the star carrier released in S1 is located in a curved pipe section, until all clamping elements of this star carrier are arranged perpendicular to the inner pipe wall;
S3: Bracing of the star carrier that was released in S1 by extending the associated clamping elements.

Steps S2-1 and S2-2 can also be combined, resulting in a movement in which lateral locomotion and tilting of the star carrier occurs simultaneously. Steps S2-1 and S2-2 may just as well be performed several times simultaneously with a small feed rate in step S2-1 before step S3 is executed.

The present inventive robot can already be adapted to pipes with different diameters without further measures by way of the length-adjustable clamping elements, as long as the adjustment length of the clamping elements is sufficient to clamp and again release the star carriers by way of the clamping elements. Examples are given below, of methods for adapting to different pipe types and application requirements when the length range of the clamping elements is no longer sufficient.

Moreover, the longitudinally adjustable clamping elements facilitate locomotion of the robot in pipes whose axial progression feature a moderate variation in the pipe's cross section.

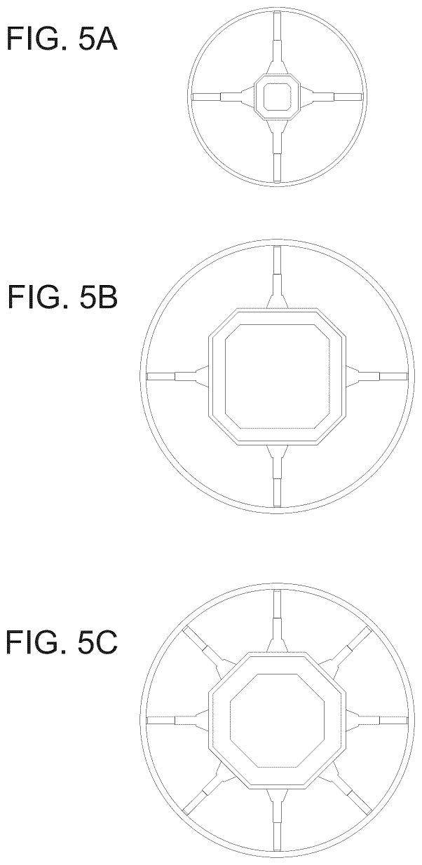

FIGS. 5A, 5B, 5C show robots according to the present invention, which were adapted to different pipe diameters and for different requirements. FIG. 5A shows a robot for a comparatively small pipe diameter, whereas FIG. 5B shows a robot for a larger pipe diameter. The two robots only differ in the size of the supporting structure. In other words, a robot for a certain pipe diameter can be adapted for a larger pipe diameter only by equipping it with larger supporting structures. All other components (clamping elements and feed element) remain identical. FIG. 5C shows a robot for the same pipe diameter as in FIG. 5B. The robot in FIG. 5C, however, has double the number of clamping elements per star carrier than the robot in FIG. 5B. Thus, the robot according to FIG. 5C is suitable for greater loads. This is especially advantageous when the robot is intended to move in vertical or very steep pipes. The embodiment according to FIG. 5C also uses the same clamping elements as are used in other parts of FIGS. 5A, 5B, 5C. In general, it is advantageous for cylindrical pipes, if the supporting structure is in the form of a regular polygon, wherein the number of sides of the polygon is equal to the number of clamping elements per star carrier.

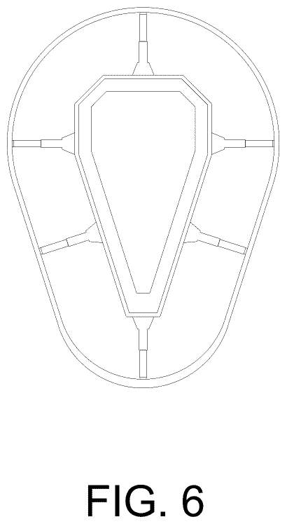

FIG. 6 shows a robot for a pipe having a non-cylindrical cross section. Also in this example, only the supporting structure was adapted compared to the robots shown in FIG. 5. Each star carrier includes 6 clamping elements. The supporting structure must be designed in such a way that the desired number of clamping elements can be attached to the latter in such a way that the feet of the clamping elements can be pressed vertically against the inner wall of the pipe.

It is advantageous if larger supporting structures consist of several segments. As a result, the supporting structure can be inserted into the pipe, disassembled into the segments. Thus, a small opening is sufficient.

In conclusion, it should be mentioned that the clamping elements can also have more than one moving part. The moving parts of the clamping elements are then guided telescopically into each other and into the stationary part. In addition, the technology known from the field of telescopic cranes can be used to guide the moving parts of the clamping elements, particularly in the case of robots that have to transport heavy loads.

### COMPONENT REFERENCE LISTING

1 Mobile Robot
2 supporting structure
3 clamping element
3.1 fixed part of a clamping element
3.2 moving part of a clamping element
3.3 foot
4 star carrier
5 feed element
6 controller
7 roller
8 hold-down element
9 sensor

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A robot for locomotion in an interior space of a pipe, the robot comprising:
at least two star carriers,
wherein each of the at least two star carriers includes a supporting structure and at least three clamping elements, wherein each of the at least three clamping elements includes a fixed part, a moving part, and a motor,
wherein, with respect to each of the at least three clamping elements, the moving part—by way of the motor—is configured for being retracted and extended along an axis with respect to the fixed part, and
wherein the fixed part of each of the at least three clamping elements is connected with the supporting structure respectively of the at least two star carriers,
wherein each of the supporting structure includes a frame with an outer contour,
wherein the fixed part of each of the at least three clamping elements is attached to the outer contour of the supporting structure respectively of the at least two star carriers such that each of the at least two star carriers is configured for being clamped onto the interior space of the pipe when the moving part of each of the at least three clamping elements is extended;
at least three feed elements,
wherein each of the at least three feed elements includes a linear drive with a motor for changing a length of the at least three feed elements respectively,
wherein a respective one of the at least three feed elements extends between two of the fixed part of two of the at least three clamping elements of adjacent ones of the at least two star carriers; and
a control unit which is configured for controlling the at least three clamping elements and the at least three feed elements.

2. The robot according to claim 1, wherein the moving part of each of the at least three clamping elements includes a foot, wherein the robot further includes an elastic element which is arranged on the foot of the moving part of each of the at least three clamping elements.

3. The robot according to claim 2, further comprising at least one roller, a hold-down element, a lever, and a hinge,
wherein the at least one roller and the hold-down element are arranged on the foot of the moving part of each of the at least three clamping elements,
wherein the foot includes an end,
wherein the at least one roller is attached to the foot by way of the lever and the hinge in such a way that the at least one roller is configured for being swung out in an axial direction of respectively the at least three clamping elements beyond the end of the foot, and
wherein the at least one roller is configured for being pressed against an inner wall of the pipe by way of the hold-down element when the foot touches the inner wall of the pipe.

4. The robot according to claim 3, wherein the hold-down element is an active actuator.

5. The robot according to claim 3, wherein the at least one roller includes two rollers which are attached to the foot of the moving part of each of the at least three clamping elements.

6. The robot according to claim 5, wherein the hold-down element (9) is a spring element.

7. The robot according to claim 3, wherein the at least three feed elements respectively form a connection with the at least three clamping elements, wherein the connection is configured for allowing the at least three feed elements to be tilted respectively in relation to the at least three clamping elements, and wherein the control unit is configured for controlling the at least three feed elements independently of each other.

8. The robot according to claim 3, further comprising a force sensor which is arranged respectively on the foot of the moving part of the at least three clamping elements, the force sensor being configured for detecting a force with which the foot is pressed against the inner wall of the pipe.

9. The robot according to claim 3, further comprising a distance sensor which is located on the foot of the moving part of the at least three clamping elements, the distance sensor being configured for detecting a distance between the foot and the inner wall of the pipe.

10. The robot according to claim 1, wherein the robot is configured for performing a method for adapting the robot to a pipe having a large diameter, the method including the steps of: replacing existing ones of the supporting structure by larger ones of the supporting structure, wherein the at least three clamping elements and the at least three feed elements remain unchanged.

11. The robot according to claim 1, wherein the robot is configured for performing a method for adapting the robot to a greater load, the method including the steps of: increasing a number of the at least three clamping elements for each respective one of the at least two star carriers.

12. The robot according to claim 1, wherein the robot is configured for performing a method for adapting the robot to a pipe having a non-cylindrical cross-section, the method including the steps of:
providing that the moving part of each of the at least three clamping elements includes a foot;
replacing existing ones of the supporting structure by other ones of the supporting structure; and
attaching associated ones of the at least three clamping elements to the other ones of the supporting structure, such that the foot of each of the at least three clamping elements is pressed vertically against an inside wall of the pipe.

13. A method of locomotion of a robot, the method comprising the steps of:
providing a robot for locomotion in an interior space of a pipe, the robot including:
at least two star carriers,
wherein each of the at least two star carriers includes a supporting structure and at least three clamping elements, wherein each of the at least three clamping elements includes a fixed part, a moving part, and a motor,
wherein, with respect to each of the at least three clamping elements, the moving part—by way of the motor—is configured for being retracted and extended along an axis with respect to the fixed part, and
wherein the fixed part of each of the at least three clamping elements is connected with the supporting structure respectively of the at least two star carriers,
wherein each of the supporting structure includes a frame with an outer contour,
wherein the fixed part of each of the at least three clamping elements is attached to the outer contour of the supporting structure respectively of the at least two star carriers such that each of the at least two star carriers is configured for being clamped onto the interior space of the pipe when the moving part of each of the at least three clamping elements is extended;
at least three feed elements,
wherein each of the at least three feed elements includes a linear drive with a motor for changing a length of the at least three feed elements respectively,
wherein a respective one of the at least three feed elements extends between two of the fixed part of two of the at least three clamping elements of adjacent ones of the at least two star carriers; and
a control unit which is configured for controlling the at least three clamping elements and the at least three feed elements,
wherein the pipe is a straight pipe;
releasing a respective one of the at least two star carriers by retracting associated ones of the at least three clamping elements;
moving the respective one of the at least two star carriers which was released in the step of releasing in a direction of locomotion by changing the length of the at least three feed elements connected with the respective one of the at least two star carriers; and
bracing the respective one of the at least two star carriers which was released in the step of releasing by extending associated ones of the at least three clamping elements.

14. A method of locomotion of a robot, the method comprising the steps of:
providing a robot for locomotion in an interior space of a pipe, the robot including:
at least two star carriers,
wherein each of the at least two star carriers includes a supporting structure and at least three clamping elements, wherein each of the at least three clamping elements includes a fixed part, a moving part, and a motor,
wherein, with respect to each of the at least three clamping elements, the moving part—by way of the motor—is configured for being retracted and extended along an axis with respect to the fixed part, and
wherein the fixed part of each of the at least three clamping elements is connected with the supporting structure respectively of the at least two star carriers,
wherein each of the supporting structure includes a frame with an outer contour,
wherein the fixed part of each of the at least three clamping elements is attached to the outer contour of the supporting structure respectively of the at least two star carriers such that each of the at least two star carriers is configured for being clamped onto the interior space of the pipe when the moving part of each of the at least three clamping elements is extended,
wherein the moving part of each of the at least three clamping elements includes a foot;
at least three feed elements,
wherein each of the at least three feed elements includes a linear drive with a motor for changing a length of the at least three feed elements respectively,
wherein a respective one of the at least three feed elements extends between two of the fixed part of two of the at least three clamping elements of adjacent ones of the at least two star carriers;
a control unit which is configured for controlling the at least three clamping elements and the at least three feed elements;
an elastic element which is arranged on the foot of the moving part of each of the at least three clamping elements;
at least one roller;
a hold-down element;
a lever; and
a hinge,
wherein the pipe is a curved pipe,
wherein the at least one roller and the hold-down element are arranged on the foot of the moving part of each of the at least three clamping elements,
wherein the foot includes an end,
wherein the at least one roller is attached to the foot by way of the lever and the hinge in such a way that the at least one roller is configured for being swung out in an axial direction of respectively the at least three clamping elements beyond the end of the foot, and
wherein the at least one roller is configured for being pressed against an inner wall of the pipe by way of the hold-down element when the foot touches the inner wall of the pipe,
wherein the at least three feed elements respectively forming a connection with the at least three clamping elements,
wherein the connection is configured for allowing the at least three feed elements to be tilted respectively in relation to the at least three clamping elements,
wherein the control unit is configured for controlling the at least three feed elements independently of each other;
releasing a respective one of the at least two star carriers by retracting associated ones of the at least three clamping elements;
moving the respective one of the at least two star carriers which was released in the step of releasing in a direction of locomotion by changing the length of the at least three feed elements connected with the respective one of the at least two star carriers;
tilting the respective one of the at least two star carriers which was released in the step of releasing in the direction of locomotion by changing the length of the at least three feed elements connected with the respective one of the at least two star carriers for an event that the respective one of the at least two star carriers which was released in the step of releasing is located in a curved section of the pipe, until each of the at least three clamping elements of the respective one of the at least two star carriers which was released in the step of releasing is arranged perpendicular to the inner wall of the pipe; and
bracing the respective one of the at least two star carriers which was released in the step of releasing by extending associated ones of the at least three clamping elements.
